(19) United States
(12) Patent Application Publication
(10) Pub. No.: US 2006/0231132 A1
(43) Pub. Date: Oct. 19, 2006

(54) PHOTOVOLTAIC GENERATOR WITH THERMO SWITCH ELEMENT

(76) Inventor: Thomas Neussner, Kolitzheim-Zeilitzheim (DE)

Correspondence Address: Henry M. Feiereisen;Henry M. Feiereisen, LLC, Suite 4714, 350 Fifth Avenue, New York, NY, 10118, US

(21) Appl. No.: 11/279,163

(22) Filed: Apr. 10, 2006

(30) Foreign Application Priority Data
Apr. 18, 2005 (DE) 10 2005 017 835.9

(51) Int. Cl. H02N 6/00

(52) U.S. Cl. 136/244; 136/293

(57) ABSTRACT

A photovoltaic system includes a photovoltaic generator, and a thermo switch which reduces an output voltage of the photovoltaic generator in response to a trigger temperature. The photovoltaic generator may include a plurality of photovoltaic cells which are arranged in series to form a photovoltaic module. The module has ends, each of which having an electric module terminal pole, wherein the thermo switch is rendered operative in response to the trigger temperature to short-circuit the module terminal poles and to thereby reduce the output voltage generated by the photovoltaic generator.

### CROSS-REFERENCES TO RELATED APPLICATIONS

This application claims the priority of German Patent Application, Serial No. 10 2005 017 835.9, filed Apr. 18, 2005, pursuant to 35 U.S.C. 119(a)-(d), the content(s) of which is/are incorporated herein by reference.

### BACKGROUND OF THE INVENTION

The present invention relates, in general, to a photovoltaic generator.

To ensure clarity, it is necessary to establish the definition of several important terms and expressions that will be used throughout this disclosure. The term “photo- voltaic generator” relates to any photovoltaic component which is capable to convert sun energy into an electrical current. Examples includes an individual photovoltaic cell, or an intermediate arrangement, such as, e.g. interconnection of a plurality of photovoltaic modules forming a photovoltaic string, or a complete system forming a photovoltaic device in its entirety. In the following description the term “photo-voltaic generator” may also be referred to in short as “generator” for sake of simplicity.

Photovoltaic devices are known in the art and gain more and more relevance, particularly in countries which provide governmental support. The present invention is less directed to large solar power plants which are mounted in the countryside but more to small units in the range of a plurality of KW electrical power. Such units are usually mounted on roofs of buildings.

Photovoltaic systems include usually a plurality of photovoltaic modules (in the following called “modules”) which are arranged in series and are combined to a string. A plurality of these strings is connected in parallel to each other to thereby form a photovoltaic system. An inverter is arranged in parallel to the strings for converting the generated direct current into an alternating current for further use of the electric energy. Within the meaning of the term “photovoltaic generator”, the inverter shall not be part of the generator. A single module includes a plurality of photovoltaic cells (in the following described as cells) which are electrically interconnected in series. Each of the cells is capable, according to current technology, to deliver ca. 2.5 watt, i.e. a current of 5 amperes when a voltage of 0.5 Volt is applied of a standard cell. Under the assumption of, for instance, 120 cells contained in a module, a voltage of 60 volts is generated across the terminal poles of the module. A voltage of 480 volts is applied between the ends of a string if, for instance, eight of such modules are connected in series to form the string.

This voltage is transferred to the fire fighter in case of an extinguishing action with help of water or foam via the jet of water/foam. When standing with wet boots in a puddle, the fire fighter has only little transition resistance to ground, and is exposed to a current surge of about 500 volts, causing serious risk of injury.

It would therefore be desirable and advantageous to provide an improved photovoltaic generator which obviates prior art shortcomings and which is able to provide safe conditions for a fire fighter or any other person participating in extinguishing a fire that may be encountered in residential building as well as commercial buildings.

### SUMMARY OF THE INVENTION

According to one aspect of the present invention, a photovoltaic system includes a photovoltaic generator; and a thermo switch which reduces an output voltage of the photovoltaic generator in response to a trigger temperature.

According to another feature of the present invention, the thermo switch reduces the output voltage of the photovoltaic module to zero.

A reduction of the output of the generator is always related to a reduction of the voltage at at least parts of the photovoltaic generator due to the structural principle of solar systems.

Accordingly, the thermo switch can be located at the module itself, e.g. at its backside. Alternatively or additionally the thermo switch may short-circuit a complete string and thus take the voltage away from it. A further alternative or additional measure provides for the short-circuiting of the photovoltaic device as a whole. The reduction in voltage leads to a reduced danger for the extinguishing helper.

According to an advantageous basic embodiment of the invention, a photovoltaic generator may include a plurality of photovoltaic cells arranged in series, which as a whole form a photovoltaic module, with the module having at each end of the series of cells an electric module terminal pole, wherein the thermo switch short-circuits the module terminal poles upon response and thus effects a reduction of the power of the photovoltaic generator.

According to a further advantageous basic embodiment of the invention, a photovoltaic generator may include a string of in series connected photovoltaic modules, wherein at each end of the string an electric string terminal pole is provided, and wherein the thermo switch short-circuits the two string terminal poles upon response and thus effects a reduction of the power of the photovoltaic generator.

According to a still further advantageous basic embodiment of the invention, a photovoltaic generator may include a plurality of electrically parallel arranged strings of in series connected photovoltaic modules, and an inverter having two DC input terminals being electrically arranged in parallel to the strings, wherein the thermo switch short-circuits the two DC input terminals upon response and thus effects a reduction of the power of the photovoltaic generator.

The term “thermo switch” is understood throughout this description as any switching element which initiates a switching operation upon reaching a desired or predetermined threshold value of a temperature or another fire indicating parameter, such as smoke, visibility through air, ionization of air, CO content etc, whereby the switching operation leads directly or indirectly to the opening or closing of an electrical path. Thereby a thermo switch with a mechanically based effect may be used, such as a bimetal. On the other hand a thermo switch based on an electrically or electronically based trigger operation is likewise applicable. In the latter case a temperature or smoke sensor (e.g. located on the back of a module) or a standard fire detector on the ceiling in one of the building's rooms cooperates with or includes an evaluation circuit for initiating the short-circuiting operation. The switching operation may be initiated by an anyhow installed fire detection system as a pre-caution measure.

According to another feature of the present invention, the photovoltaic module is provided with a connector box, and the thermo switch which is related to the photovoltaic module is housed within the box or is attached to it. Such a box is anyhow attached or fixed to the back of the module. Further, an integration of the mounting of the thermo switch during the manufacturing process of the module is preferred to reduce the hours of site assembling.

The thermo switch may have a predefined or an adjustable triggering or switching temperature. The provision of a predefined triggering temperature is appropriate when a thermo switch is applied which is directly connected to a single module. The module and its maximum power are generally known to enable calculation of a maximum operation temperature. The triggering or switching temperature is chosen a little bit higher, e.g. within a range of 5° C. to 15° C. higher than the expected maximum operating temperature. An adjustable switching temperature may be considered, when the thermo switch is connected between the ends of a string or across the poles of an inverter. In this case the temperature can be determined in light of the maximum string or system power, respectively, and the thermo switch can be adjusted taking into account these values, and the switching temperature may thus be tailored to the individual layout of the solar system. The switching temperatures may be chosen to be within a range of 60° C. to 100° C., advantageously between 70° C. and 90° C.

It is evident that within a single photovoltaic system a plurality of thermo switches with a differing correlation to components of the system can be included. In other words, each of the modules may have its own thermo switch and that additionally further thermo switches may be provided, which effect the short-circuiting of one or more strings or of the complete system.

The easiest way to establish a reduction in power is the afore mentioned short-circuiting of electrical paths, e.g. between the poles of one of the components module, string, inverter and/or overall system.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic illustration of a photovoltaic generator which is provided with a thermo switch;

FIG. 2 is a schematic illustration of a plurality of photovoltaic modules being arranged in series to form a string, wherein a thermo switch is associated with the string; and

FIG. 3 is a schematic illustration of a plurality of photovoltaic strings, which are connected parallel to each other to form a large photovoltaic system, wherein a thermo switch is related to the complete photovoltaic system.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

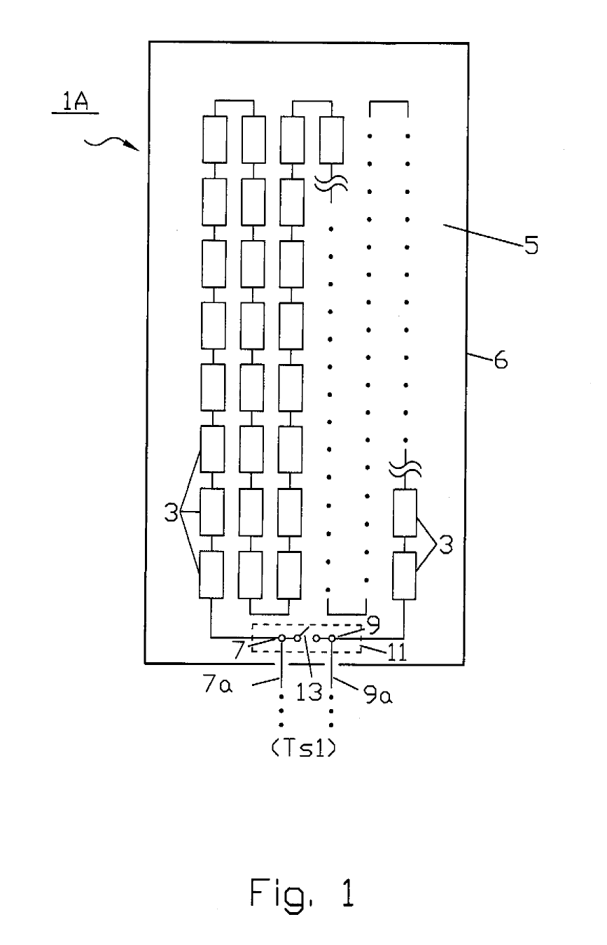

Turning now to the drawing, and in particular to FIG. 1, there is shown a schematic illustration of a photovoltaic generator, generally designated with reference sign 1A. The generator 1A comprises a plurality of photovoltaic cells 3, which form the smallest generator unit for the conversion of sun energy into electric current. This plurality of cells 3, for example 120, is connected in series to each other and forms a photovoltaic module 5. The module 5 may be mounted within a module box 6. The two ends of the series circuit are the two terminal poles 7, 9 of the module 5. The poles 7, 9 are connected to or into a connector box (see dotted lines) which is attached to the side or the back of the module 5. The conductors which lead to the outside of the module 5 are designated with 7a and 9a. A thermo switch 13 is provided between the terminal poles 7, 9 of the module 5. The switch 13 closes if a limit, threshold or switching value of a temperature Ts1 is reached. The thermo switch 13 may be arranged at another location than the shown one within or attached to the box 11; however, the mentioned position is particularly suitable. Upon response or closure, the thermo switch 13 causes a short-circuit between the terminal poles 7, 9. The d.c. voltage between the terminal poles 7, 9 breaks down due to this short-circuit, and the module is essentially free of voltage. Accordingly, there is no danger for an extinguishing person in case of a fire.

It should be observed, that the thermo switch 13 may be placed outside of the terminal box 11 at a location particularly exposed to danger. This can effect a fast response under certain circumstances.

It may also be conceivable, to provide each single cell 3 with its own related thermo switch 13 to attain the desired effect. This, however, appears prohibitive as far as costs are concerned.

The thermo switch 13 may be based on a mechanical or an electronic principle. Thus, it may be a bimetal element, for example. It can be an electronic sensor with an associated evaluation circuit as well. The thermo switch 13 should be mounted already during the production of the module 5.

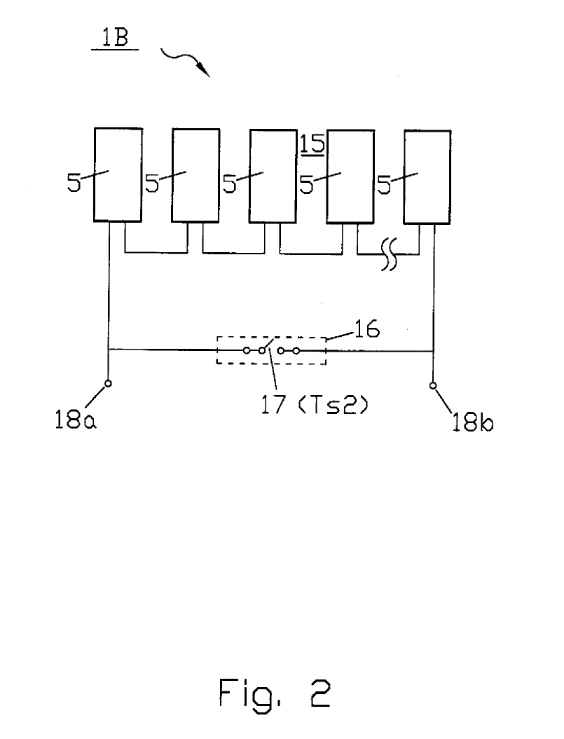

According to the photovoltaic generator 1B of FIG. 2, a plurality of modules 5 as shown in FIG. 1 is connected in series with each other. They are thus combined to a string 15. The length of the string 15 may vary between five and ten modules 5.

The string 15 is provided with a thermo switch 17 for achieving the desired electrical short-circuit in case of thermal danger. The thermal switch 17 is housed within or attached to a connecting case 16 associated to the string 15. The thermo switch 17 may be provided additionally to the module thermo switches 13 which are related to each single module 5. The thermo switch 17 reacts upon reaching a predetermined limit or switching temperature Ts2. Upon a response the switch 17 short-circuits the string terminal poles 18a, 18b which are provided at the end of each string 15. The limit or switching temperature Ts2 of the thermo switch 17 may be chosen different to that (Ts1) of the module thermo switch 13.

It is to be mentioned that the photovoltaic generator 1B according to FIG. 2 may include modules 5 which are not provided with the module thermo switch 13. This reduces the costs accordingly.

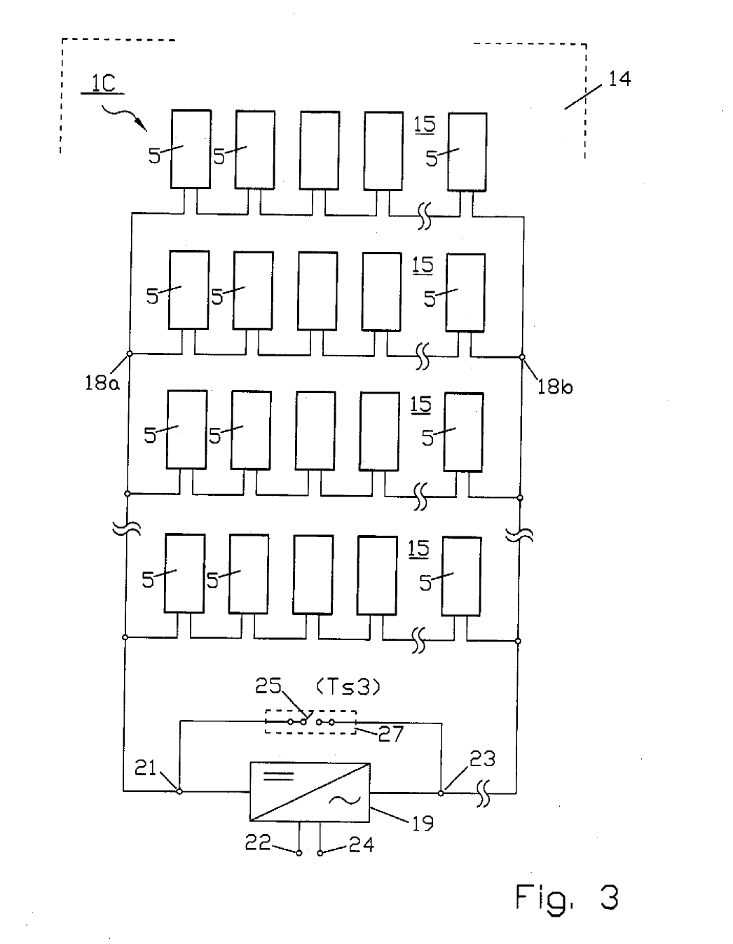

The photovoltaic generator 1C shown in FIG. 3 includes a plurality of strings 15 which are connected in parallel and thus form a complete photovoltaic system or a mayor part of such a system. This is indicated by an apparatus or system case 14. It is appropriate to integrate the plurality of string thermo switches 17 within the system case 14.

In analogy to above, it is to be mentioned that the photovoltaic generator 1C according to FIG. 3 may include modules 5 which are not provided with the module thermo switch 13. This reduces costs.

An inverter 19 is connected in parallel to the strings 15 and has two input terminals 21, 23. In other words: The connecting cases 16 of the strings 15 are electrically connected with the d.c. input terminals 21, 23 of the inverter 19. The a.c. voltage terminals are designated with reference numerals 22 and 24. The input terminals 21, 23 are short-circuited with help of another thermo switch 25 which may be disposed within a further terminal case 27. The system thermal switch 25 is activated upon reaching a predetermined or adjustable limit, switching or triggering temperature Ts3. When a fire occurs with the consequence that the limit temperature Ts3 is reached, the high output voltage at the terminals 21, 23 of the inverter 19 is considerably reduced or set to zero. This drastically reduces or even prevents any risk of injury to a person when approaching the photovoltaic system 1C to extinguish the fire.

The predetermined or adjusted switching temperatures Ts1, Ts2 , Ts3 may range from 60° C. to 100° C., advantageously between 70° C. and 90° C. As a consequence of these selected or adjusted values, the occurrence of a fire is reliably detected, so that the switch-off of the voltage which is photovoltaically generated can safely be achieved.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A photovoltaic system, comprising a photovoltaic generator; and a thermo switch which reduces an output voltage of the photovoltaic generator in response to a trigger temperature.

2. The photovoltaic system of claim 1, wherein the thermo switch reduces the output voltage of the photovoltaic module to zero.

3. The photovoltaic system of claim 1, wherein the photovoltaic generator includes a plurality of photovoltaic cells arranged in series to form a photovoltaic module, said module having ends, each end having an electric module terminal pole, wherein the thermo switch is rendered operative in response to the trigger temperature to short-circuit the module terminal poles and to thereby reduce the output voltage generated by the photovoltaic generator.

4. The photovoltaic system of claim 3, wherein the photovoltaic generator includes a string of a plurality of said photovoltaic module connected in series, wherein each end of the string is provided with an electric string terminal pole, and wherein the thermo switch is rendered operative in response to the trigger temperature to short-circuit the string terminal poles and to thereby reduce the output voltage of the photovoltaic generator.

5. The photovoltaic system of claim 4, wherein the photovoltaic generator includes a plurality of said string, and further comprising an inverter having two DC input terminals and electrically arranged in parallel to the strings, wherein the thermo switch is rendered operative in response to the trigger temperature to short-circuit the two DC input terminals and to thereby reduce the output voltage of the photovoltaic generator.

6. The photovoltaic system of claim 3, wherein the photovoltaic module is provided with a connector box, with the thermo switch being disposed in or on the connector box.

7. The photovoltaic system of claim 6, wherein the thermo switch is installed during production of the photovoltaic module or during production of the connector box.

8. The photovoltaic system of claim 4, wherein the string is provided with a connecting case, with the thermo switch being disposed in or on the connecting case.

9. The photovoltaic system of claim 1, wherein the thermo switch includes an effective mechanical component.

10. The photovoltaic system of claim 9, wherein the mechanical component is a bimetal element.

11. The photovoltaic system of claim 1, wherein the thermo switch includes an effective electrical component.

12. The photovoltaic system of claim 11, wherein electrical component is a temperature sensor in connection with an evaluation circuit.

13. The photovoltaic system of claim 1, wherein the trigger temperature is between 70° C. and 90° C.

14. A photovoltaic generator, comprising
a photovoltaic cell generating an output voltage across output terminals; and
an electric switch connected across the output terminals, said switch responsive to a temperature,
wherein the electric switch short-circuits the output terminals in response to an increase in temperature above a threshold value, thereby reducing the output voltage of the photovoltaic generator to a safe level.

15. The photovoltaic generator of claim 14, comprising a plurality of said photovoltaic cell connected in series and forming a photovoltaic module, with the output voltage being generated across output terminals of the photovoltaic module.

16. The photovoltaic generator of claim 15, comprising a plurality of said photovoltaic module connected in series and forming a photovoltaic assembly, with the output voltage being generated across output terminals of the photovoltaic assembly.

17. The photovoltaic generator of claim 15, comprising
a plurality of said photovoltaic module connected in series, with the series-connected photovoltaic modules being electrically connected with one another in parallel so as to have common output terminals, and
an inverter having a DC input connected across the common output terminals,
wherein the electric switch short-circuits the common output terminals.

18. The photovoltaic generator of claim 15, comprising a connector box, wherein the electric switch is attached to or housed in the connector box.

19. The photovoltaic generator of claim 14, wherein the electric switch is installed in or on the connector box when the photovoltaic module or the connector box are manufactured.

20. The photovoltaic generator of claim 16, wherein the photovoltaic assembly includes a connector case, and the electric switch is housed in the connector case or attached to the connector case.

21. The photovoltaic generator of claim 14, wherein the electric switch includes a mechanical actuator.

22. The photovoltaic generator of claim 14, wherein the mechanical actuator includes a bimetal element.

23. The photovoltaic generator of claim 14, wherein the electric switch includes an electrical or electronic actuator.

24. The photovoltaic generator of claim 23, wherein the electrical or electronic actuator includes a temperature sensor and an evaluation circuit providing an actuation signal to the electrical or electronic actuator in response to an input signal from the temperature sensor.

25. The photovoltaic generator of claim 14, wherein the temperature threshold value is between approximately 60° C. to 100° C.

26. The photovoltaic generator of claim 14, wherein the temperature threshold value is between approximately 70° C. and approximately 90° C.

27. The photovoltaic generator of claim 14, wherein the safe level of the output voltage is between approximately 0 Volt and approximately 60 Volt.
